(19) United States
(12) Patent Application Publication
(10) Pub. No.: US 2018/0113669 A1
(43) Pub. Date: Apr. 26, 2018

(54) SYSTEM FOR FACILITATING SMARTPHONE OPERATION IN A VIRTUAL REALITY ENVIRONMENT

(71) Applicant: Nano Magnetics Ltd., Markham (CA)

(72) Inventor: Timothy Jing Yin Szeto, Mississauga (CA)

(73) Assignee: Nano Magnetics Ltd., Markham (CA)

(21) Appl. No.: 15/789,840

(22) Filed: Oct. 20, 2017

Related U.S. Application Data
(60) Provisional application No. 62/411,468, filed on Oct. 21, 2016.

(51) Int. Cl. G06F 3/14; G06F 3/0346; G06F 3/0481; G06K 19/06

(52) U.S. Cl. CPC G06F 3/1454; G06K 19/06037; G06F 3/04815; G06F 3/0346

(57) ABSTRACT

A virtual reality system may facilitate use of a physical smartphone by rendering a corresponding virtual smartphone within a virtual reality environment. Screencast data originating from the physical smartphone may be emulated on a screen of the virtual smartphone in the virtual reality environment. User customizations of the physical smartphone screen, if any, may thus be mirrored on the screen of the virtual smartphone. Indicator or button states of the physical smartphone may also be emulated on the virtual smartphone. The virtual reality system may track a position and orientation of the physical smartphone and may effect analogous changes in position or orientation of the virtual smartphone.

### CROSS-REFERENCE TO RELATED APPLICATIONS

The present application claims the benefit of prior U.S. provisional application Ser. No. 62/411,468 filed Oct. 21, 2016, the contents of which are hereby incorporated by reference hereinto.

### TECHNICAL FIELD

The present disclosure relates to virtual reality systems, and more particularly to a system for facilitating smartphone operation in a virtual reality environment.

### BACKGROUND

Virtual reality (VR) systems allow users to visualize and interact with 3D virtual (i.e. computer-generated) environments. Various commercial systems are available at the time of this writing, such as HTC Vive™, Oculus Rift™, PlayStation VR™, Google Cardboard™, HoloLens™, Gear VR™, DayDream View™, and Sulon Q™. A typical VR system may include a VR headset, at least one VR controller, and a VR host computer.

The VR headset may be a set of opaque goggles that are strapped or held to a user's face. The goggles incorporate a display upon which images representing the virtual environment are presented in stereoscopic 3D. When the user views the images through lenses in the headset, an illusion of depth is created. The VR headset typically incorporates one or more sensors (e.g. inertial or optical sensors) for dynamically sensing a current position and orientation of the headset in space, as the user moves his head to “look around” the VR environment.

A VR controller is a mechanism by which a user interacts with the VR environment. The VR controller may be a handheld device similar to a video game controller, with various buttons, touchpads or other controls for entering user commands. Alternatively, the VR controller may be a device that is worn by the user, e.g. in the manner of a glove, that generates user commands in response to a user's movements or gestures. The user commands may be for triggering actions in the VR environment, such as touching or picking up a proximate virtual object. The VR controller typically incorporates one or more sensors for sensing a current position and/or orientation of the controller, similar to the VR headset.

The VR host computer is a computing device responsible for generating the VR environment. Its primary responsibility is to render images representing whatever portion of the VR environment the user is currently viewing (e.g. as determined based on sensors in the VR headset) and interacting with (e.g. as determined based on sensors in the VR controller), and to output those images to the VR headset for display to the user in near real time. The rendering may combine data from at least three data sources: (1) a database or library of objects representing a “map” of the 3D virtual environment; (2) signals from sensors in the VR headset indicative of the user's current head position and orientation; and (3) signals from sensors and controls in the VR controller(s) indicative of the user's current hand position(s) and any recently issued user commands. In some embodiments, a smartphone may serve as, or may take the place of, the VR host computer. Such a smartphone may form part of, or may be situated within, the VR headset.

Some VR systems may also use area sensors. Area sensors are sensors mounted at fixed points within a physical area (e.g. on the walls of a room) occupied by the user. These sensors may track the user's location and/or body posture within the area. Signals from the area sensors may feed into the VR host computer and may provide an additional data source for use by the rendering algorithm, e.g. to help track a user's movements within the VR environment. Area sensors may be ultrasonic, optical or electromagnetic sensors, among others.

### SUMMARY

In one example embodiment, a virtual reality (VR) system comprises: at least one area sensor operable to detect at least one spatial marker in fixed relation to a physical smartphone; and a VR host computer in communication with the at least one area sensor and the physical smartphone, the VR host computer operable to: receive screencast data originating from the physical smartphone; receive spatial data originating from the at least one area sensor, the spatial data representing either or both of a position and an orientation of the physical smartphone in three-dimensional space; and based at least in part upon the spatial data and the screencast data, render a three-dimensional virtual smartphone in a virtual reality environment that is a facsimile of the physical smartphone.

In another example embodiment, a virtual reality (VR) host computer comprises: a graphics processing unit (GPU); and memory storing instructions that, when executed by the GPU, cause the VR host computer to: render a virtual smartphone within a virtual reality environment, the virtual smartphone having a screen; based on screencast data originating from a physical smartphone, emulate a graphical user interface (GUI) of the physical smartphone on the screen of the virtual smartphone in the virtual reality environment; and output video data representing the virtual smartphone having the emulated GUI of the physical smartphone.

In another example embodiment, a physical smartphone comprises: a screen for presenting a graphical user interface (GUI); a housing containing the screen; at least one physical spatial marker, in fixed relation to the housing, detectable by one or more area sensors of a virtual reality system; and a processor operable to cause the physical smartphone to screencast the GUI for use by the virtual reality system in rendering a virtual smartphone, in a virtual reality environment, that emulates the GUI of the physical smartphone.

### BRIEF DESCRIPTION OF DRAWINGS

In the figures which illustrate example embodiments:

FIG. 1 is a perspective view of a user of a first embodiment of a virtual reality system for facilitating use of a physical smartphone without exiting a virtual reality environment;

FIG. 1A and FIG. 1B are front elevation views of a physical smartphone displaying digital spatial markers detectable by optical area sensors of a virtual reality system;

FIG. 2 is a schematic diagram of the virtual reality system of FIG. 1;

FIG. 3 is a schematic diagram of a VR host computer component of the VR system of FIG. 2;

FIG. 4 is a flowchart of operation of the VR host computer of FIG. 3;

FIG. 5 is a perspective view of a user of a second embodiment of a virtual reality system for facilitating use of a physical smartphone without exiting a virtual reality environment;

FIG. 6 is a schematic diagram of the virtual reality system of FIG. 5;

FIG. 7 is a perspective view of a user of a third embodiment of a virtual reality system for facilitating use of a physical smartphone without exiting a virtual reality environment;

FIG. 8 is a schematic diagram of the virtual reality system of FIG. 7;

FIG. 9 is a perspective view of a user of a fourth embodiment of a virtual reality system for facilitating use of a smartphone without exiting a virtual reality environment; and

FIG. 10 is a schematic diagram of the virtual reality system of FIG. 9.

### DETAILED DESCRIPTION

The present disclosure describes a virtual reality system that is designed to facilitate access to, or operation of, a smartphone by a user of the VR system. The system may allow a user, who is immersed in a virtual environment, to conveniently access a virtual representation of his or her physical smartphone without exiting the virtual environment. The appearance and functionality of the virtual smartphone can be made to mimic that of the user's own physical smartphone, which may increase efficiency in two ways. Firstly, a familiar interface of the virtual smartphone may promote quick, efficient use of the virtual smartphone, thereby minimizing processor cycles and associated power consumed during use of the virtual smartphone. Secondly, by electing to stay within the VR environment to use his or her smartphone, the user may avoid VR system downtime and context switching delays that would result if the user were required to exit the VR environment every time it became necessary to access his or her physical smartphone. This may allow the user to conveniently access his or her smartphone, e.g. to view incoming text or social media messages and respond to them, to place or take a voice call, or to engage in a video teleconference, while remaining in the VR environment.

The VR system may be implemented in a variety of different ways. Four example embodiments, referred to herein as “Embodiments A-D,” are described below. The embodiments are ordered in diminishing order of “virtual smartphone realism,” i.e. of how closely the virtual reality experience of operating the smartphone, according to the embodiment in question, emulates or approximates the use of a physical smartphone in the physical world. For clarity, the term “virtual smartphone” is used herein to refer to a representation of a smartphone in the virtual reality environment.

### Embodiment A

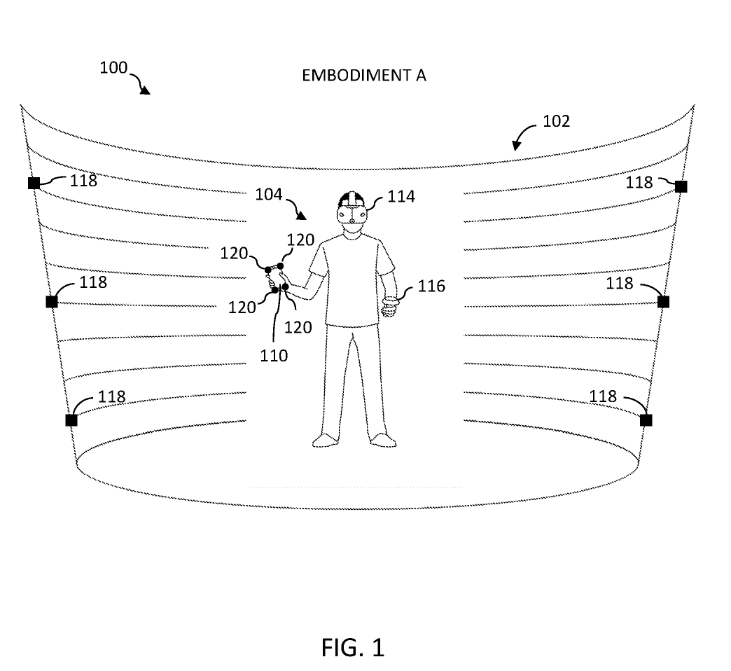

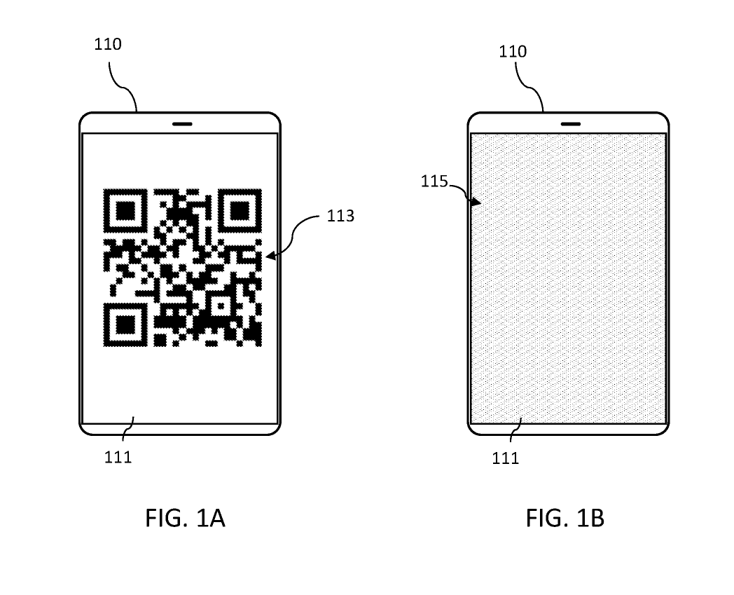

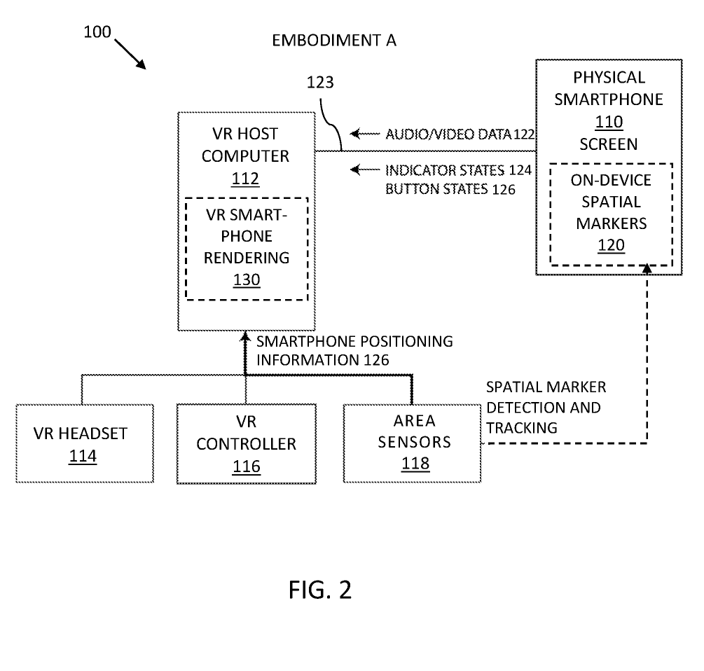

FIGS. 1 and 2 depict a first VR system 100 for facilitating operation of a physical smartphone in a VR environment. FIG. 1 depicts use of the system 100 in a physical area 102 by a user 104. FIG. 2 is a schematic block diagram of the system 100. The VR system 100 of Embodiment A is designed to provide an intuitive virtual smartphone user interface in the VR environment that approximates the look and feel of using the user's own physical smartphone.

Referring to FIG. 1, an example user 104 wearing an example VR headset 114 holds a VR controller 116 in his left hand and an example physical smartphone 110 in his right hand. The VR headset 114 may be a conventional VR headset, including a stereoscopic display and sensors for detecting head position and orientation. In some embodiments, the VR headset may include speakers (headphone) and a microphone. The VR controller 116 may be a conventional VR controller.

The physical smartphone 110 is the user's own physical smartphone and thus has been customized according to the user's preferences. Customizations may include: positioning/ordering of icons on the smartphone touchscreen or display (or simply “screen”), e.g. icons associated with smartphone applications or “apps;” selection of visual or auditory user notifications for events such as incoming email messages, text messages, social media events or telephone calls received via the smartphone (the visual notifications appearing either on the screen or via hardware indicators beyond the screen, e.g. flashing LEDs); selection of a wallpaper or background image for the smartphone screen; installation of software or “apps;” user data such as address book information, call history, documents, photographs; and others.

The smartphone comprises a housing containing a screen and internal circuitry including a processor in communication with memory comprising volatile and non-volatile memory, among other components. In one example embodiment, the processor is a Qualcomm™ Kryo™ CPU, the memory is double data rate (DDR) synchronous DRAM and SD flash storage, and the screen is an active-matrix organic light-emitting diode (AMOLED) screen. The processor and memory may comprise a single “system on a chip” (SoC) integrated circuit, such as the Snapdragon™ 835 SoC from Qualcomm™ for example, which is designed specifically for use in mobile devices.

The example physical smartphone 110 of FIG. 1 is tagged with four physical spatial markers 120, each in a corner of the smartphone 100 in this embodiment, in fixed relation to the smartphone housing. The spatial markers 120 are designed to be readily detectable by area sensors 118, described below, to facilitate detection of smartphone position and orientation. Different types and numbers of physical spatial markers may be used in different embodiments. In some embodiments, the spatial markers 120 may for example be stickers, dots or spheres of highly reflective material attached to the smartphone 110, e.g. via adhesive. In some embodiments, the spatial markers may be reflective elements integrated with the smartphone housing or a case into which the physical smartphone 110 has been placed prior to using VR system 100.

In other embodiments, the spatial markers may not be physical. Rather, the spatial markers may be one or more digital markers generated on the smartphone screen, e.g., overlaid over or replacing regular content. The VR host computer may send instructions to the phone for generating these types of markers in a way that allows tracking by sensors 118. The spatial marker(s) on the screen may for example be one or more uniquely identifiable patterns, such as a two-dimensional barcode 113 (e.g. a QR code) occupying at least a portion (e.g. a majority) of the screen 111 of smartphone 110, as illustrated in FIG. 1A. Multiple such barcodes could be displayed simultaneously in some embodiments, e.g. with one situated at each of the four corners of the screen.

Alternatively, digital spatial marker(s) may simply be a two-dimensional shape having a predetermined color hue. The color hue may be similar to that used for “green screen” Chroma keying video effects, e.g. as used for television news or weather reporting. For example, with reference of FIG. 1B, the entirety of the rectangular smartphone screen 111 may display a predetermined color hue 115, such as green. The area sensors 118 (FIG. 1) may be able to detect smartphone position and orientation by detecting the size and position of the green rectangle as well as a degree of its apparent deformation from one or more perspectives.

The physical area 102 (FIG. 1) may be a room. A plurality of area sensors 118 are fixedly mounted within the area 102, e.g. by being attached to a wall. The area sensors 118 may track the location and/or body posture of user 104, as well as the current orientation and position of the physical smartphone 110, within the area 102. The area sensors 118 may be optical sensors. In some embodiments, the area sensors may be ultrasonic or electromagnetic sensors. Six area sensors 118 are used in the VR system 100 of FIG. 1. The number of area sensors in alternative embodiments may be less than or greater than six.

Referring to FIG. 2, the VR system 100 includes a VR host computer 112. The VR host computer 112 is a computing device responsible for generating the VR environment. Its primary responsibility is to render images representing whatever portion of the VR environment the user 104 (FIG. 1) is currently viewing (e.g. as determined based on sensors in the VR headset 114) and interacting with (e.g. as determined based on sensors in the VR controller 116), and to output those images to the VR headset 114 for display to the user in near real time.

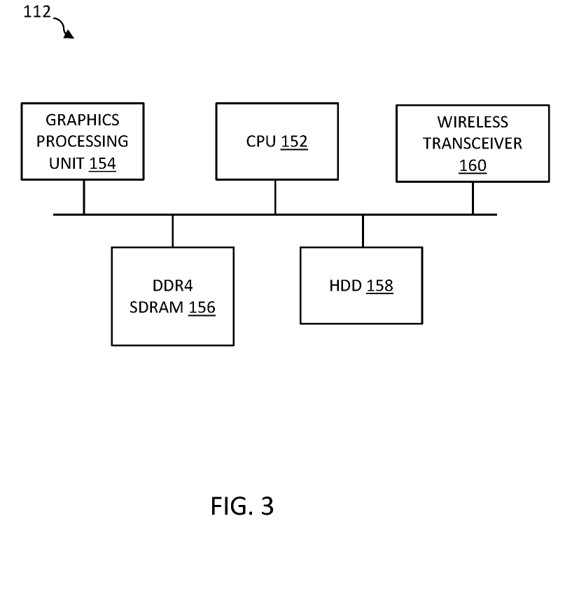

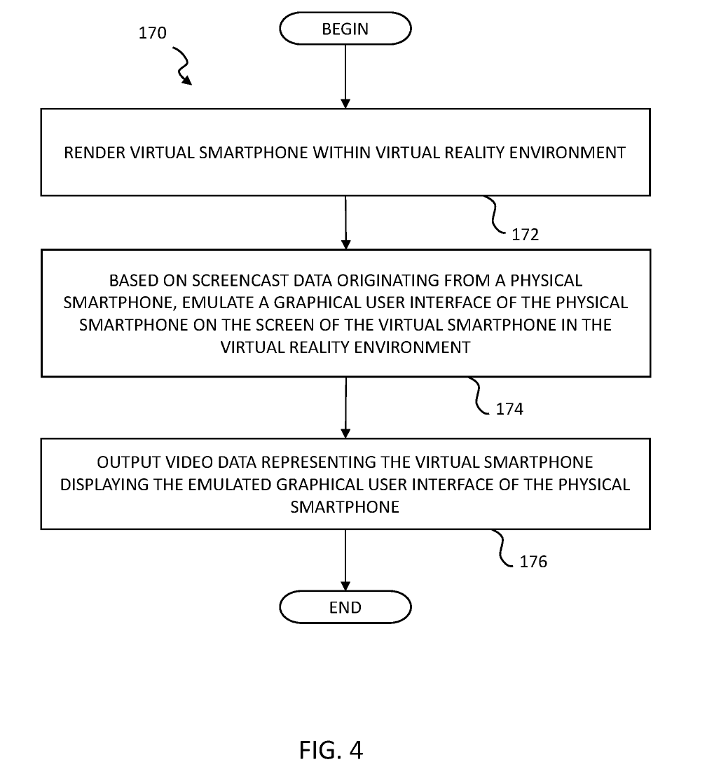

A schematic diagram of an example VR host computer 112 is depicted in FIG. 3. The computer 112 is a computing device having a central processing unit (CPU) 152 and a graphics processing unit (GPU) 154. The processors are communicatively coupled, e.g. in a similar manner as in a contemporary gaming PC. Notably, the functionality of the GPU 154 differs from that of a GPU in a contemporary gaming PC at least in terms of the functionality represented by the flowchart of FIG. 4, described below. The example VR host computer 112 also includes double data rate fourth-generation (DDR4) synchronous dynamic random-access memory (SDRAM) 156 (a form of volatile memory) and a hard disk drive (HDD) 158 (a form of non-volatile memory). The VR host computer 112 may include other components; these are omitted from FIG. 3 for the sake of clarity.

In one example embodiment, the computing device comprising VR host computer 112 may be a personal computer including the following components:
Motherboard: ASRock™ H270 Pro4
CPU: Intel™ Core i5-7500
GPU: AMD™ RX 480 (or GeForce GTX 1060 3 GB)
RAM (volatile memory): 8 GB DDR4-2400
Secondary Storage (non-volatile memory): Seagate™ Barracuda™ 1 TB HDD
Power Supply: EVGA 500B
Case: Corsair™ 200R
CPU Cooler: Arctic Freezer 13

In another example embodiment, the computing device comprising VR host computer 112 may be a personal computer including the following components:
Motherboard: MSI™ B350M Gaming Pro
CPU: AMD™ Ryzen™ 5 1600
GPU: GeForce™ GTX 1070
RAM: 16 GB DDR4
Secondary Storage (non-volatile memory) 1: Crucial™ MX300 275 GB
Secondary Storage 2: Seagate™ Barracuda™ 2 TB HDD
Power Supply: EVGA GQ 650W
Case: Corsair™ Carbide 270R

The VR host computer 112 depicted in FIG. 3 further incorporates a wireless transceiver 160, which may for example be one of a Wi-Fi™ transceiver, a Bluetooth™ transceiver, or a cellular data transceiver. In some embodiments, the wireless transceiver may form part of a PCI Express Mini (mPCIe) peripheral card, which is removable from a motherboard to facilitate upgrades for evolving communication standards. In one example, the wireless transceiver may be a Broadcom™ BCM4360 5G WiFi 3-Stream 802.11ac Gigabit Transceiver. The wireless transceiver 160 is operable to receive wireless signals from the smartphone 110 representing screencast data, as will be described.

The rendering performed by VR host computer 112 may be considered to combine data from five data sources: (1) a database or library of objects representing a “map” of the 3D virtual environment, which may be stored in memory forming part of the computer 112 (e.g. HDD 158); (2) signals from sensors in the VR headset 114 indicative of the current head position and head orientation of user 104; (3) signals from sensors and controls in the VR controller 116 indicative of the current hand position of user 104 and any recently issued user commands; and (4) signals from area sensors 118 indicative of a position of the user 104, and of position and orientation of physical smartphone 110, within physical area 102. The fifth data source is described below.

In some embodiments, a 3D gaming engine, such as the Unity™ or Unreal™ 3D gaming engine, may be used to facilitate this combination of data. Such gaming engines provide 3D rendering functionality as used in 3D video games, e.g. allowing 3D objects to be rendered with a particular texture, color and/or shading based on available lighting conditions and player (user) perspective. If used, the 3D gaming engine may be executed by a combination of the CPU 152 and the GPU 154.

The rendering performed by VR host computer 112 includes VR smartphone rendering 130, which generates a virtual facsimile of the user's physical smartphone in the virtual reality environment. Operation 170 of the VR host computer 112 for smartphone rendering 130 may be as depicted in FIG. 4.

In a first operation 172 of FIG. 4, a virtual smartphone is rendered within the virtual reality environment. In the present embodiment, the virtual smartphone is rendered as a 3D object. The virtual smartphone has a screen similar to that of the physical smartphone, which may be referred to as virtual screen.

Based on screencast data originating from the physical smartphone 110, a graphical user interface (GUI) of the physical smartphone 110 is emulated on the virtual screen of the virtual smartphone in the virtual reality environment (operation 174, FIG. 4). This operation may be conceptualized as a “pasting” of the screencast from the physical smartphone onto the virtual screen the virtual smartphone.

More specifically, the VR host computer 112 receives audio/video data 122, including a periodic or continuous screencast from smartphone 110, over a connection 123 between the smartphone 110 and the VR host computer 112. In the illustrated embodiment, the connection 123 may be a wireless connection, which may be effected over WiFi™ or Bluetooth using Google™ Cast, Miracast™ (Microsoft™), or other similar mechanisms for wirelessly communicating video content from a mobile device to another device (e.g. for display on a larger monitor or HDTV). The screencast data may for example be encoded using a known video compression standard, such as the H.264 or MPEG-4 Part 10, Advanced Video Coding (MPEG-4 AVC) standard. In the illustrated embodiment, the screencast data is received via the wireless transceiver 160 (FIG. 3). In alternative embodiments, the connection 123 may be a physical connection, e.g. using an HDMI, DisplayPort, MHL, or HDMI cable. The provision of the audio/video data 122 may be facilitated by a hardware RGB or DVI frame grabber card (not expressly depicted).

To implement screencasting, API calls to the operating system of physical smartphone 110 or third party API calls may be used to capture individual frames or to receive a stream of video data. Third party screencast APIs are available for many mobile OS's, including Android™, iOS™, Blackberry™ OS and Windows™ Mobile.

Analogous steps may be taken to obtain information from physical smartphone 110, over connection 123, regarding current indicator states 124 and button states 126 at the smartphone 110. Button states may be standard API calls, e.g. as per the following table:

| PHYSICAL | | |
|---|---|---|
| KEY | KEY CONSTANT | DESCRIPTION |
| POWER key | KEYCODE_POWER | Turns on the device or |
| | | wakes it from sleep |
| BACK key | KEYCODE_BACK | Navigates to the |
| | | previous screen |
| HOME key | KEYCODE_HOME | Navigates to the home |
| | | screen |
| SEARCH | KEYCODE_SEARCH | Launches a search |
| key | | |
| CAMERA | KEYCODE_CAMERA | Launches the camera |
| button | | |
| VOLUME | KEYCODE_VOLUME_UP | Controls volume |
| button | KEYCODE_VOLUME_DOWN | |

The above KeyEvent class constants may have callback methods used to pass button states, e.g.:

onKeyDown( )

onKeyUp( )

onKeyLongPress( )

Touch Events may also be captured via:

onTrackballEvent( )

onTouchEvent( )

These calls may return discrete user inputs from the physical smartphone 110 and can be passed to the VR host computer 112, which may interpret the physical inputs on the device and may update a 3D model state including any smartphone buttons (e.g. showing the buttons as being physically depressed) and indicators (e.g., flashing LEDs) and or the user's hand position. Button states, indicator states and audio notifications from the physical smartphone may thus be mirrored or mimicked on the virtual smartphone.

The screencast smartphone audio/video data 122, as well as any indicator states 124 and button states 126, may be considered as the fifth source of data for combination with the other four sources, described above, at the VR host computer 112. Upon receipt, this fifth data stream may be mapped, transcoded, or converted to have the same format as that in which other virtual reality data, such as virtual objects or textures, are encoded. This conversion may facilitate incorporation of smartphone audio/video data 122, indicator states 124, and button states 126 into the virtual reality environment.

Ultimately, video data representing the virtual smartphone displaying the emulated GUI of the physical smartphone 110, and optionally emulated button and/or indicator states (if any), is then output by the GPU 154 (FIG. 3) of the VR host computer 112 (operation 176, FIG. 4). For example, two video streams, one comprising a left eye perspective and the other comprising a right eye perspective, may be output by the GPU for use by the VR headset 114 (FIG. 1) in generating the left eye and right eye images, respectively.

It will be appreciated that the VR smartphone rendering 130 at VR host computer 112 may reproduce or emulate visual and auditory notifications normally occurring at the physical device on the virtual smartphone in the virtual reality environment via a 3D virtual smartphone that is a facsimile of the physical smartphone 110. This may be referred to herein as “mirroring” the UI of the physical smartphone. In some embodiments, A/V outputs may be disabled or deactivated on the physical smartphone 110 to avoid dual notifications or conserve power. This may for example be achieved using similar mechanism(s) as may be used to stream a YouTube™ video from a physical smartphone with the smartphone screen being deactivated, while allowing the user to engage buttons, including volume, power, screen. Alternatively, this may be achieved using a screen standby app via root or non-root privileges. For clarity, when a GUI screencast from a physical smartphone screen whose screen is disabled or deactivated is emulated on a virtual smartphone screen, this may still be considered as a form of “mirroring” despite the fact that the physical smartphone screen does not present that GUI.

The VR smartphone rendering 130 also causes the virtual smartphone in the VR environment to emulate any movement (e.g. rotation, translation) of the physical smartphone 110 that is being held in the user's hand. This is done using information from area sensors 118 representing detection and tracking of spatial markers 120.

To enter smartphone commands, the user 104 may hold the physical smartphone in his hand and interact with it (e.g. touch the touchscreen, press buttons, etc.) as he would normally to activate desired smartphone functions or applications. Although the user 104 may be unable to see the physical smartphone 110 due to the VR headset 114, which is opaque, the user's actions may be guided by visual feedback via the virtual smartphone in the VR environment, which mimics the physical smartphone 110 in near real time. In an embodiment, the visual feedback may comprise so-called “touch blobs,” i.e. visual feedback on a touchscreen confirming a point at which the touchscreen was just touched. Each touch blob may for example appear as a circle expanding from the coordinates of a most recent physical contact of the touchscreen, similar to ripples expanding on the surface of a pond from a thrown pebble.

In some embodiments, the VR controller 116 may also play a role in the user's interaction with the virtual smartphone in the virtual reality environment. For example, the VR controller 116 could be used to control a “virtual finger,” to situate a pointer upon the virtual smartphone interface. The user 104 may hold the smartphone in one hand and use the other hand as a pointing device to be interpreted by the smartphone as a human interface device (HID) event. In this case, the VR host computer 112 may detect smartphone commands being entered via the virtual smartphone in the virtual reality environment via signals from the VR controller 116 and generate corresponding commands for the physical smartphone 110. These generated commands may be sent to the physical smartphone 110 over connection 123, e.g. in the form of API calls.

### Embodiment B

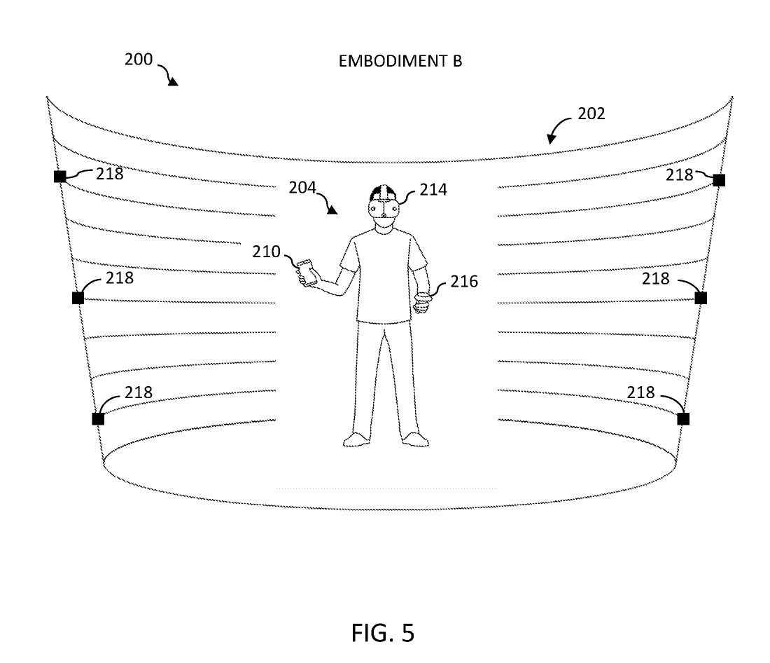

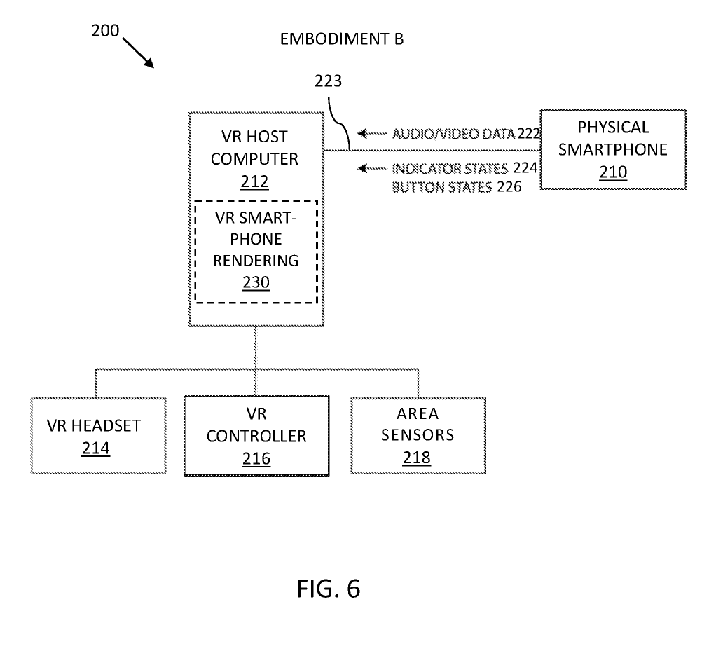

FIGS. 5 and 6 depict a second VR system 200 for facilitating operation of a smartphone in a VR environment. In particular, FIG. 5 depicts use of the system 200 in a physical area 202 by a user 204, and FIG. 6 is a schematic block diagram of the system 200. The VR system 200 is similar to VR system 100 of Embodiment A, with the exception that the virtual smartphone of system 200 may be 2D instead of 3D and does not emulate any movement of the physical smartphone 210 held by the user 204.

Referring to FIG. 5, a user 204 wearing a VR headset 214 holds an example VR controller 216 in his left hand and an example physical smartphone 210 in his right hand. As in Embodiment A, the physical smartphone 210 is the user's own physical smartphone and thus has been customized according to the user's preferences. However, unlike Embodiment A, the physical smartphone 210 is not tagged with any physical or digital spatial markers. This may reduce a cost and complexity of the system 200.

A plurality of area sensors 218 are fixedly mounted within the physical area 202 occupied by the user 204. The area sensors 218 may track the location and/or body posture of user 204. However, unlike the area sensors 118 of Embodiment A, sensors 218 of Embodiment B do not track the current orientation or position of the physical smartphone 110, in view of the lack of any spatial markers on the physical smartphone 210.

Referring to FIG. 6, the VR system 100 includes a VR host computer 212, VR headset 214, VR controller 216, and area sensors 218, which are generally analogous in function to the components of the same name of Embodiment A, described above.

The VR host computer 212 of FIG. 6 is generally responsible for rendering the virtual reality environment. The computer 212 performs VR smartphone rendering 230 differently than in Embodiment A. For example, the VR smartphone rendering 230 of Embodiment B may render the virtual smartphone as a 2D object, e.g. having the appearance of a heads-up display for example, rather than as a 3D object. Alternatively, the virtual smartphone may be rendered as a 3D object whose appearance is modeled after that of the user's own physical smartphone, including any user customizations of the GUI, button states, indicator states and audio user notifications, as in Embodiment A. However, regardless of whether the virtual smartphone is being rendered as a 2D or 3D object, the VR smartphone rendering 230 of Embodiment B does not emulate any movement of the physical smartphone 210. This may reduce a complexity of the system 200 and may reduce computational demands upon VR host computer 212.

As in Embodiment A, the VR smartphone rendering performed by the VR host computer 212 of Embodiment B may employ techniques such as “pasting” a GUI screencast from the physical smartphone 210 onto the screen of a 2D heads up display or 3D virtual smartphone, and mimicking the button states, indicator states and audio notifications from the physical smartphone on the virtual smartphone. This may be done based on audio/video data 222, indicator states 224, and button states 226 from physical smartphone 210, which may be received over a connection 223 between the smartphone 210 and the VR host computer 212. The connection 223 may be a physical (e.g. wired) or wireless connection analogous to connection 123 of Embodiment A.

It will be appreciated that, in Embodiment B, the data received at VR host computer 212 from area sensors 218 will not include any information regarding the position and orientation of physical smartphone 210 within physical area 202, as noted above.

To enter smartphone commands in Embodiment B, the user 204 may hold the physical smartphone 210 in his hand and interact with it as he would normally. Although the user 204 may be unable to see the physical smartphone 210 due to the VR headset 214, which is opaque, the user's actions may be guided by visual feedback via the virtual smartphone in the VR environment similar to what is done in Embodiment A. In Embodiment B, the visual feedback may constitute a mimicking, general approximation, or other representation of user interface events from physical smartphone 210 on the virtual smartphone in near real time.

In Embodiment B, the VR controller 216 may play a role in the user's interaction with the virtual smartphone in the virtual reality environment, as may optionally be done in Embodiment A, but this is not required.

### Embodiment C

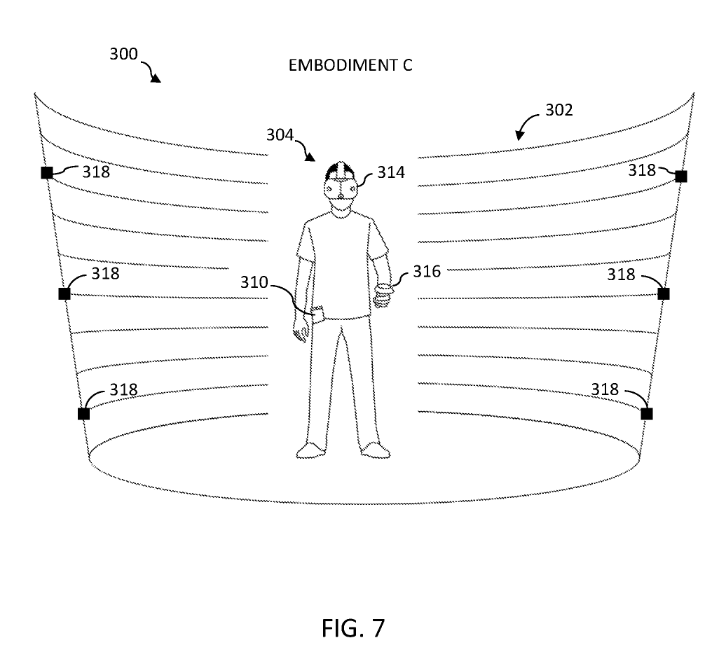

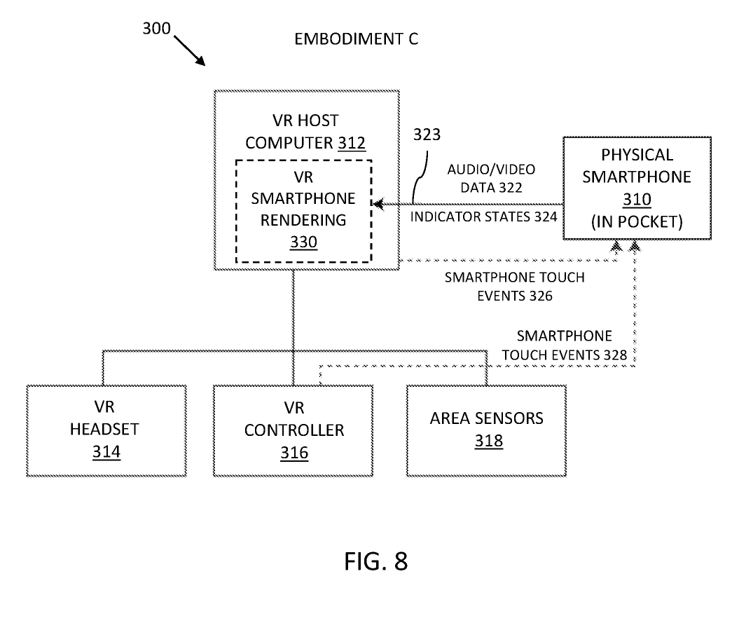

FIGS. 7 and 8 depict a third VR system 300 for facilitating operation of a smartphone in a VR environment. In particular, FIG. 7 depicts use of the system 300 in a physical area 302 by a user 304, and FIG. 8 is a schematic block diagram of the system 300. The VR system 300 is similar to VR system 200 of Embodiment B, with the exception that no physical smartphone is used for entering smartphone commands.

Referring to FIG. 7, a user 304 wearing an example VR headset 314 holds an example VR controller 316 in his left hand and keeps an example physical smartphone 310 nearby, e.g. in his pocket. As in both above-described embodiments, the physical smartphone 310 of the present embodiment is communicatively coupled to the VR host computer (not expressly depicted in FIG. 7), e.g. using a cable or, for improved mobility, wirelessly. The physical smartphone 310 of Embodiment C is the user's own physical smartphone and thus has been customized according to the user's preferences. The physical smartphone 310 is not held by the user 304 because it is not needed (will not be used) to enter any smartphone commands.

A plurality of area sensors 318, as in the preceding embodiments, are fixedly mounted within the physical area 302 occupied by the user 304. The area sensors 318 may track the location and/or body posture of user 304.

Referring to FIG. 8, the VR system 300 includes a VR host computer 312, VR headset 314, VR controller 316, and area sensors 318, which function analogously to the components of the same name of FIG. 6 above.

At VR host computer 312, the VR smartphone rendering 330 renders the virtual smartphone either as a 2D object or as a 3D object. In the former case, the virtual smartphone may have the appearance of a heads-up display for example. In the latter case, the virtual smartphone may appear as a 3D object modeled after the appearance of the user's own physical smartphone, including any user customizations of the GUI, button states, indicator states and audio user notifications. As in Embodiment B, the VR smartphone rendering 330 of Embodiment C does not emulate any movement of the physical smartphone 310.

The VR host computer 312 may employ techniques such as “pasting” a GUI screencast from the physical smartphone 310 onto the screen of a 3D virtual smartphone or 2D heads up display, and mimicking the indicator states and audio notifications of the physical smartphone on the virtual smartphone. This may be done based on audio/video data 322 and indicator states 324 from physical smartphone 310. This information may be received over the wired or wireless connection 323 between the smartphone 310 and the VR host computer 312, as alluded to above. Notably, because the physical smartphone is not being manipulated, the physical buttons of the physical smartphone (e.g. power button, volume buttons, etc.) will not physically change state. FIG. 8 does not depict any button state information flowing from the physical smartphone 310 to the VR host computer 312. The reason is that controls on VR controller 316 are used to control the virtual smartphone. Thus, any change of state would be simulated at the VR host computer based on inputs from the controller.

Because the user 304 neither holds nor manipulates the physical smartphone 310 in the present embodiment, smartphone commands are entered using the VR controller 316. For example, the VR controller 316 may be used to control a “virtual finger,” to situate a pointer upon the virtual smartphone interface. The VR host computer 312 may detect smartphone commands being entered via the virtual smartphone in the virtual reality environment and may generate corresponding commands for the physical smartphone 110. The generated commands may be sent to the physical smartphone 310 over connection 323, e.g. in the form of API calls.

As an example, the VR controller 316 of Embodiment C may be used to enter a smartphone command, such as placing a telephone call, by way of the following sequence of events:
User 304 (FIG. 7) initially establishes a connection 323 (FIG. 8) between the physical smartphone 310 and the VR host computer 312 by pairing them via a wireless protocol like Bluetooth™, Wi-Fi™, or otherwise
User 304 specifies that VR controller 316 is to be used for entering smartphone commands (or may occur by default in this embodiment)
User 304 places physical smartphone 310 nearby, e.g. in a pocket, with connection 323 being maintained
VR host computer 312 receives audio/video 322 and indicator states 324 from physical smartphone 310 over connection 323. Optionally, the display and/or audio at the physical smartphone 310 may be disabled for power conservation and/or to eliminate notification redundancy
User 304, via VR controller 316, motions in a predetermined way to activate his smartphone
The VR smartphone rendering functionality 330 at VR host computer 312 renders a virtual smartphone in the VR environment. The virtual smartphone may be presented in 2D (e.g. as a HUD) in certain embodiments or as a 3D model in other embodiments.
The nearby physical smartphone 310 communicates its present state to the VR host (e.g. audio/video data 322 and indicator states 324)
At VR host computer 312, the VR smartphone rendering 330 uses the received information to mimic, approximate or otherwise represent the present state of the physical smartphone's UI on the face of the virtual smartphone
The user 304 navigates to a phone application on the virtual smartphone by manipulating the VR controller 316. In the case where the VR controller 316 has a touchpad, touch events may be sent back to the physical smartphone 310 and interpreted as local Human Interface Device events.
By interacting with the virtual smartphone (using the VR controller 316), the user 304 enters a command to cause a telephone call to be placed. Corresponding commands are relayed to the phone app on the physical smartphone 310 over connection 323, e.g. via suitable API calls.
The VR host computer 312 forwards sounds captured by a microphone of VR headset 314, e.g. user speech, to the physical smartphone 310, for transmission to the called party. In the opposite direction, the VR host computer 312 receives audio, e.g. a ringing sound or the called party's voice, from the telephone application at the physical smartphone 310 and relays the audio to speakers (headphones) in the VR headset 314.
The user 304 is thereby able to conduct the telephone call while remaining in the virtual reality environment.
The user may end the telephone call by pressing an ‘end call’ button or similar construct on the UI of the virtual smartphone, using VR controller 316.

In some embodiments, the VR controller 316 may be used to activate not only physical buttons at the physical smartphone 310 (e.g. volume control, ringer mute, etc.) but also software based UI controls. This may for example be done using an emulator (e.g. Genymotion™ emulator for Android™ devices), which is executing at the VR host computer 312 and using smartphone functionality forming part of the smartphone operating system (e.g. in at least some version of Android available at the time of this writing).

### Embodiment D

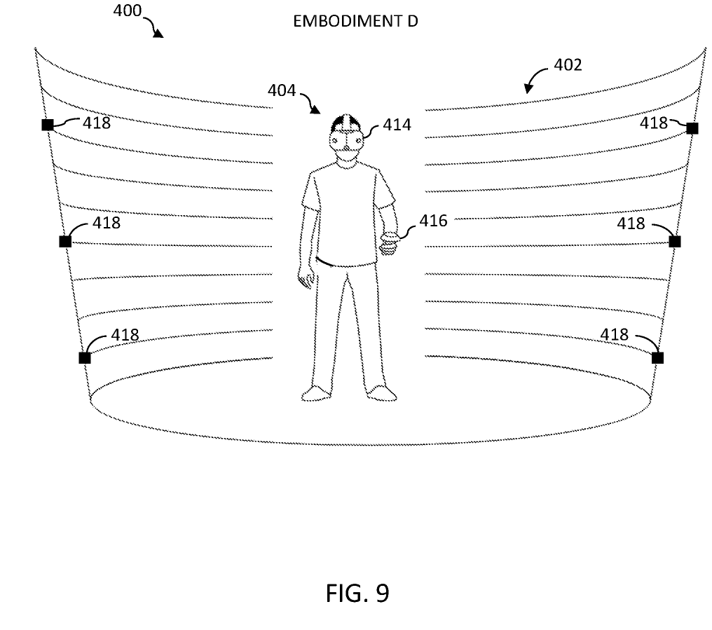

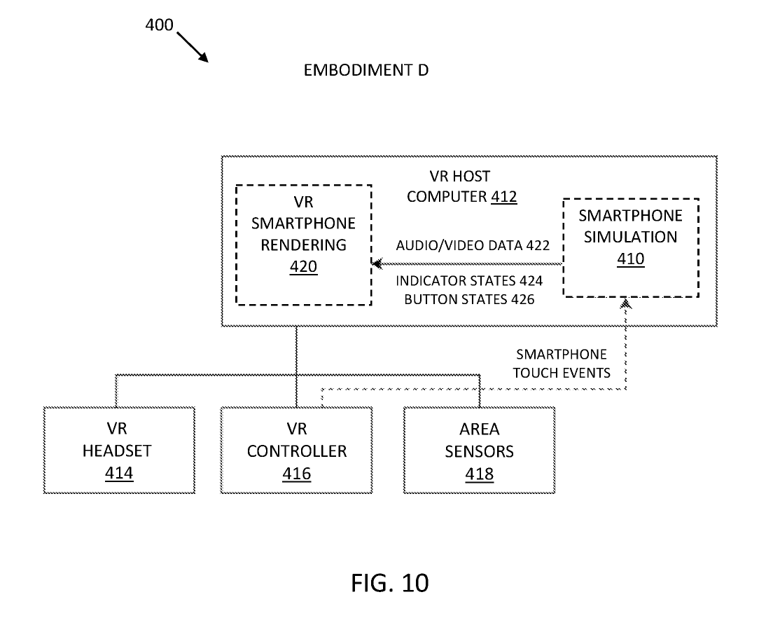

FIGS. 9 and 10 depict a fourth VR system 400 for facilitating operation of a smartphone in a VR environment. In particular, FIG. 9 depicts use of the system 400 in a physical area 402 by a user 404, and FIG. 10 is a schematic block diagram of the system 400.

The VR system 400 differs from the Embodiments A-C in that it does not incorporate any physical smartphone. Instead, the VR host computer executes smartphone simulation software to simulate a generic (non-user specific) smartphone, as described below.

The virtual smartphone of Embodiment D may be considered as the “least realistic” virtual smartphone of the four embodiments, because the virtual smartphone will not reflect any user customizations of the physical smartphone of the user 404. From a perspective of the user 404, Embodiment D may be similar to borrowing another person's smartphone or “demoing” a smartphone, e.g. for the purpose of exploring new hardware, software or environmental coordination without needing to purchase a new device or install new software.

Referring to FIG. 9, a user 404 wears a VR headset 414 and holds a VR controller 416 in his left hand. A plurality of area sensors 418 are fixedly mounted within the physical area 402 occupied by the user 404. The area sensors 418 may track the location and/or body posture of user 404. As in all previous embodiments, all of these devices are communicatively coupled to a VR host computer 412 (not depicted in FIG. 9 but described below in conjunction with FIG. 10).

Referring to FIG. 10, the VR system 400 includes a VR headset 414, VR controller 416, and area sensors 418, which function analogously to the components of the same name of FIG. 8 above.

As in Embodiment C, the system 400 includes a VR host computer 412 whose general responsibility is to render a virtual reality environment and to render, using smartphone rendering functionality 420, a virtual smartphone with which the user can interact while in the VR environment. However, unlike the VR host computer 312 of Embodiment C, the VR host computer 412 of Embodiment D does not “translate” or relay smartphone commands entered using VR controller 416 to the user's physical smartphone. Moreover, in the reverse direction, the VR host computer 412 of Embodiment D does not receive screencast audio/video data, indicator states, or buttons states from the physical smartphone for application to a virtual smartphone in the virtual reality environment. Instead, the VR host computer 412 additionally executes smartphone simulation software 410 that behaves like a generic (non user-specific) smartphone, avoiding the need for any communication with a physical smartphone.

The smartphone simulation software 410, which may be a commercial product, may be designed to accept smartphone commands and output UI information such as screen information, audio user notifications, or visual user notifications. For example, the software 410 may be a fully virtualized mobile OS capable of standard functionality of a mobile OS including app store downloads, UI customizations, reading of personal email, web browsing, and so forth. This is in contrast to the VR smartphone rendering software 410, which is generically operable to render a virtual smartphone but requires external input as to the smartphone's audio/video output, indicator states, and button states.

At VR host computer 412, the virtual smartphone may be rendered either as a 2D object or as a 3D object. In the former case, the virtual smartphone may have the appearance of a heads-up display for example. In the latter case, the virtual smartphone may appear as a 3D object.

As in previous embodiments, the VR host computer 412 of the present embodiment may employ techniques such as “pasting” a screencast onto the screen of a 2D heads up display or 3D virtual smartphone, and mimicking smartphone button states, indicator states and audio notifications. However, as noted above, the source of the audio/visual data 422, indicator states 424 and button states 426 is not a physical smartphone, but rather is the smartphone simulation software 410. Since the smartphone simulation software 410 may represent an entire, functional mobile OS, the only difference between using it, versus a physical smartphone, may be the routing of wireless protocols: where a physical device may require the use of a wireless protocol for connection, the smartphone simulation software 410 may be capable of emulating wireless connections instead.

Smartphone commands may be entered using the VR controller 416, as in Embodiment C above for example. The generated commands may be translated into suitable API calls and relayed to the smartphone simulation software 410.

Other embodiments are possible.

For example, in the foregoing disclosure, the smartphone 110, host computer 112, and headset 114 were depicted as three separate devices. Each of these could be a smartphone. Thus, the system could be implemented using three smartphones. A smartphone can be adapted to be a headset using technology similar to Google Daydream™, or Samsung VR™.

Further, the same functionality could be implemented in two devices instead of three. For example, the operations of the host computer 112 could be performed by the physical smartphone 110. Also, the VR host computer 112 could also be integrated with the VR headset 114 (or even the VR controller 116). When the user is not holding the smartphone (e.g., embodiment C or D), the phone could be integrated into headset (again using technology similar to Google Daydream™ or Samsung VR™).

Some embodiments (e.g., C and D) can even be implemented using one device. In this case, the physical smartphone may be head-mounted and may function as the VR headset and the VR host, and may work in conjunction with a handheld VR controller.

When the physical smartphone is head-mounted, the physical smartphone display may show the 3D VR environment. Meanwhile, the virtual phone's display may show the regular smartphone screen data (e.g., corresponding to applications, icons, etc.). The screen data may be generated by the physical smartphone in a screen buffer that is not displayed in the real world, and is then “pasted” onto the screen of the virtual smartphone.

Although embodiments described above describe the use of DDR4 SDRAM for volatile memory and an HDD for non-volatile memory, other forms of volatile or non-volatile memory may be used.

Other modifications may be made within the scope of the claims.

What is claimed is:

1. A virtual reality (VR) system comprising:
at least one area sensor operable to detect at least one spatial marker in fixed relation to a physical smartphone;
a VR host computer in communication with the at least one area sensor and the physical smartphone, the VR host computer operable to:
receive screencast data originating from the physical smartphone;
receive spatial data originating from the at least one area sensor, the spatial data representing either or both of a position and an orientation of the physical smartphone in three-dimensional space; and
based at least in part upon the spatial data and the screencast data, render a three-dimensional virtual smartphone in a virtual reality environment that is a facsimile of the physical smartphone.

2. The VR system of claim 1 wherein the physical smartphone has a user-customized GUI and wherein the rendered virtual smartphone emulates the user-customized GUI of the physical smartphone.

3. The VR system of claim 1 wherein the VR host computer is further operable to:
receive data representing user input entered via the physical smartphone; and
provide visual or auditory feedback, via the virtual smartphone in the virtual reality environment, confirming receipt of the user input entered via the physical smartphone.

4. The VR system of claim 3 wherein the visual or auditory feedback provided via the virtual smartphone in the virtual reality environment mirrors visual or auditory feedback provided by the physical smartphone responsive to the user input.

5. The VR system of claim 3 wherein the user input comprises a touching of the screen of the physical smartphone at a screen location and wherein the visual or auditory feedback provided via the virtual smartphone in the virtual reality environment indicates the screen location at which the physical smartphone was touched.

6. The VR system of claim 5 wherein the visual or auditory feedback comprises a graphical touch indicator displayed on the screen of the virtual smartphone at a screen location corresponding to a screen location at which the screen of the physical smartphone was touched.

7. The VR system of claim 1 wherein the VR host computer is further operable to:
receive data from the at least one area sensor indicative of a change in position or orientation of the physical smartphone in three-dimensional space; and
effect an analogous change in position or orientation of the virtual smartphone in the virtual reality environment.

8. The VR system of claim 1 further comprising a VR controller in communication with the VR host computer, wherein the VR host computer is further operable to:
receive a command from the VR controller responsive to a user interaction with the virtual smartphone; and
communicate with the physical smartphone to effect a corresponding command at the physical smartphone.

9. A virtual reality (VR) host computer comprising:
a graphics processing unit (GPU);
memory storing instructions that, when executed by the GPU, cause the VR host computer to:
render a virtual smartphone within a virtual reality environment, the virtual smartphone having a screen;
based on screencast data originating from a physical smartphone, emulate a graphical user interface (GUI) of the physical smartphone on the screen of the virtual smartphone in the virtual reality environment; and
output video data representing the virtual smartphone having the emulated GUI of the physical smartphone.

10. The VR host computer of claim 9 wherein the GUI of the physical smartphone is user-customized and wherein the user-customized GUI is emulated on the screen of the virtual smartphone.

11. The VR host computer of claim 9 further configured to:
receive data representing user input entered via the physical smartphone; and
provide visual or auditory feedback, via the virtual smartphone in the virtual reality environment, confirming receipt of the user input entered via the physical smartphone.

12. The VR host computer of claim 11 wherein the visual or auditory feedback provided via the virtual smartphone in the virtual reality environment mirrors visual or auditory feedback provided by the physical smartphone responsive to the user input.

13. The VR host computer of claim 11 wherein the user input comprises a touching of the screen of the physical smartphone at a screen location and wherein the visual or auditory feedback provided via the virtual smartphone in the virtual reality environment indicates the screen location at which the physical smartphone was touched.

14. The VR host computer of claim 13 wherein the visual or auditory feedback comprises a graphical touch indicator displayed on the screen of the virtual smartphone at a screen location corresponding to a screen location at which the screen of the physical smartphone was touched.

15. The VR host computer of claim 9 further configured to:
receive data representing a user notification dynamically arising at the physical smartphone responsive to an event other than a user manipulation of the physical smartphone; and
emulate the user notification in the virtual reality environment.

16. The VR host computer of claim 9 wherein the virtual smartphone is three-dimensional.

17. The VR host computer of claim 16 further configured to:
receive data indicative of a change in position or orientation of the physical smartphone in three-dimensional space; and
effect an analogous change in position or orientation of the virtual smartphone in the virtual reality environment.

18. A physical smartphone comprising:
a screen for presenting a graphical user interface (GUI);
a housing containing the screen;
at least one physical spatial marker, in fixed relation to the housing, detectable by one or more area sensors of a virtual reality system; and
a processor operable to cause the physical smartphone to screencast the GUI for use by the virtual reality system in rendering a virtual smartphone, in a virtual reality environment, that emulates the GUI of the physical smartphone.

19. The physical smartphone of claim 18 wherein the at least one spatial marker comprises at least one physical spatial marker in fixed relation to the housing.

20. The physical smartphone of claim 19 wherein at least one the physical spatial marker comprises a reflective object attached to the housing.

21. The physical smartphone of claim 18 wherein the at least one spatial marker comprises a reflective element of a smartphone case that encompasses the housing.

22. The physical smartphone of claim 18 wherein the at least one spatial marker comprises a digital spatial marker and wherein the processor is operable to cause the physical smartphone to display, on the screen, the digital spatial marker.

23. The physical smartphone of claim 22 wherein the digital spatial marker comprises a two-dimensional barcode.

24. The physical smartphone of claim 22 wherein the digital spatial marker comprises a two-dimensional shape having predetermined color hue.
